(19) United States
(12) Patent Application Publication
(10) Pub. No.: US 2008/0102535 A1
(43) Pub. Date: May 1, 2008

(54) Measuring thyroxine levels from dried blood samples using mass spectrometry

(76) Inventors: Donald H. Chace, Pittsburgh, PA (US); James C. DiPerna, North Huntingdon, PA (US); Scott Singleton, Pittsburgh, PA (US)

Correspondence Address: CHOATE, HALL & STEWART LLP, TWO INTERNATIONAL PLACE, BOSTON, MA, 02110, US

(21) Appl. No.: 11/591,437

(22) Filed: Nov. 1, 2006

(51) Int. Cl. G01N 24/00

(52) U.S. Cl. 436/173

(57) ABSTRACT

Measuring thyroxine levels from dried blood samples using mass spectrometry. A test sample is provided that was obtained by treating a dried blood sample with an extraction solution. The test sample also includes an isotopically enriched thyroxine standard. The test sample is scanned using a mass spectrometer to produce one or more mass spectra and the level of thyroxine in the test sample is determined by comparing a peak in the one or more mass spectra that corresponds to thyroxine with a peak in the one or more mass spectra that corresponds to isotopically enriched thyroxine. The level of thyroxine in the dried blood sample is optionally determined based on the extraction efficiency of the extraction solution. Thyroxine levels may be measured in combination with amino acid and/or carnitine levels. Compositions and kits for practicing the method are also provided.

### BACKGROUND

Thyroxine (T₄) is a thyroid hormone involved in the control of cellular metabolism. Chemically, thyroxine is an iodinated derivative of the amino acid tyrosine and has the following structure:

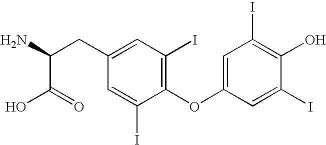

Thyroxine is stored within the thyroid and its secretion is controlled by thyroid-stimulating hormone (TSH), a hormone released from the pituitary gland. Conversely, thyroxine regulates the effect of TSH by feedback inhibition, i.e., high levels of thyroxine depress the rate of TSH secretion.

The maintenance of a normal level of thyroxine is important for normal growth and development of children as well as for proper bodily function in the adult. Its absence leads to delayed or arrested development. Hypothyroidism, a condition in which the thyroid gland fails to produce enough thyroxine, leads to a decrease in the general metabolism of all cells, most characteristically measured as a decrease in nucleic acid and protein synthesis, and a slowing down of all major metabolic processes. Conversely, hyperthyroidism is an imbalance of metabolism caused by overproduction of thyroxine. The measurement of T₄ levels can serve as a diagnostic of these and other altered thyroid functions.

The concentration of thyroxine in the bloodstream is extremely low. Less than 0.1% of the total circulating thyroxine is physiologically active (i.e., free thyroxine). The remaining circulating thyroxine is bound to proteins, primarily thyroxine binding globulin (TBG). Thyroxine will also bind to other binding proteins, particularly, thyroxine binding pre-albumin and albumin. Thyroxine levels are therefore generally recorded as “free T₄” or “total T₄” (i.e., free and bound T₄). The former is hard to measure because free T₄ levels are so low. The latter is hard to measure because the separation of bound T₄ from its protein is not always complete.

T₄ levels have been measured using immunoassays such as those disclosed in U.S. Pat. Nos. 4,636,478 and 4,888,296 to Sisbert et al.; U.S. Pat. No. 4,843,018 to Berger et al.; U.S. Pat. Nos. 5,691,456; 5,688,921; 5,648,272 and 5,593,896 to Adamczyk et al; and U.S. Pat. No. 6,153,440 to Chopra.

T₄ levels have also been measured using mass spectrometry, e.g., as described in Tai et al., “Development and evaluation of a reference measurement procedure for the determination of total 3,3′,5-triiodothyronine in human serum using isotope-dilution liquid chromatography-tandem mass spectrometry,” Anal Chem. 76(17):5092-6, 2004; Hantson et al., “Simultaneous determination of endogenous and ¹³C-labelled thyroid hormones in plasma by stable isotope dilution mass spectrometry,” J. Chromatogr. B Analyt. Technol. Biomed. Life Sci. 807(2):185-92, 2004; Hopley et al., “The analysis of thyroxine in human serum by an ‘exact matching’ isotope dilution method with liquid chromatography/tandem mass spectrometry,” Rapid Commun. Mass. Spectrom. 18(10):1033-8, 2004; Soukhova et al., “Isotope dilution tandem mass spectrometric method for T4/T3,” Clin. Chim. Acta. 343(1-2):185-90, 2004; Holm et al., “Reference methods for the measurement of free thyroid hormones in blood: evaluation of potential reference methods for free thyroxine”, Clin. Biochem. 37(2):85-93, 2004; Van Uytfanghe et al., “Development of a simplified sample pretreatment procedure as part of an isotope dilution-liquid chromatography/tandem mass spectrometry candidate reference measurement procedure for serum total thyroxine”, Rapid Commun. Mass Spectrom. 18(13):1539-40, 2004; Tai et al., “Candidate reference method for total thyroxine in human serum: use of isotope-dilution liquid chromatography-mass spectrometry with electrospray ionization”, Clin. Chem. 48(4):637-42, 2002; De Brabandere et al., “On the use of trimethylchlorosilane in methanol for methylation of thyroxine prior to perfluoroacylation and isotope dilution-gas chromatography/mass spectrometry”, J. Mass Spec. 33:1032, 1998; De Brabandere et al., “Isotope dilution-liquid chromatography/electrospray ionization-tandem mass spectrometry for the determination of serum thyroxine as a potential reference method”, Rapid Commun. Mass Spectrom. 12(16):1099-103, 1998; Thienpont et al., “Determination of reference method values by isotope dilution-gas chromatography/mass spectrometry: a five years' experience of two European Reference Laboratories”, Eur. J. Clin. Chem. Clin. Biochem. 34(10):853-60, 1996; Thienpont et al., “Development of a new method for the determination of thyroxine in serum based on isotope dilution gas chromatography mass spectrometry”, Biol. Mass Spectrom. 23(8):475-82, 1994; Siekmann, “Measurement of thyroxine in human serum by isotope dilution mass spectrometry. Definitive methods in clinical chemistry, V”, Biomed. Environ. Mass Spectrom. 14(11):683-8, 1987; Ramsden et al., “Development of a gas chromatographic selected ion monitoring assay for thyroxine (T4) in human serum”, Biomed Mass Spec. 11:421-7, 1984; and Moller et al., “Isotope dilution—mass spectrometry of thyroxin proposed as a reference method”, Clin. Chem. 29(12):2106-10, 1983.

All of these references teach mass spectral methods in which T₄ levels are measured from serum samples. The serum samples are typically subjected to a protein precipitation step followed by one or more T₄ extraction steps before mass spectral analysis. Many of the references teach methods in which free T₄ is measured (i.e., instead of total T₄ which includes the protein bound T₄). Serum samples are simpler to use since the absence of blood cells and clotting factors makes extraction of T₄ more efficient. The protein precipitation steps have also been included in order to improve the detection of the weak signals from low concentrations of T₄. In contrast, the present invention describes inter alia methods for measuring total T₄ levels from dried blood samples instead of serum and without the need for any protein precipitation steps. The inventive methods and various advantages that are associated with these over prior methods are described below.

### SUMMARY

The present invention provides a method for detecting thyroxine (T₄) levels in dried blood samples using mass spectrometry. A test sample is provided that was obtained by treating a dried blood sample with an extraction solution and optionally a reagent that derivatizes thyroxine. The test sample also includes an isotopically enriched thyroxine standard that has optionally been derivatized with the same reagent. The test sample is scanned using a mass spectrometer to produce one or more mass spectra. The level of thyroxine in the test sample is determined by comparing a peak in the one or more mass spectra that corresponds to thyroxine with a peak in the one or more mass spectra that corresponds to isotopically enriched thyroxine. Optionally, the level of thyroxine in the dried blood sample can then be determined based on the extraction efficiency of the extraction solution. If the level of thyroxine in the test sample or dried blood sample is outside the range of normal thyroxine levels then the dried blood sample or the patient from whom it was obtained may be referred for further analysis, e.g., measurement of TSH levels by immunochemical assay.

Thyroxine levels may also be measured in combination with amino acid and/or carnitine levels. According to such methods isotopically enriched amino acid and/or carnitine standards are present within the test sample. In one embodiment, these amino acid and/or carnitine standards have been derivatized by treatment with the same reagent as the thyroxine standard. Ratios of thyroxine levels to amino acid and/or carnitine levels may be used to reduce the occurrence of false positives and/or negatives.

Compositions and kits that are used in practicing the inventive methods are also provided. Thus, the invention provides compositions that include an isotopically enriched thyroxine standard in combination with an isotopically enriched amino acid standard and/or an isotopically enriched carnitine standard. The invention also provides compositions in which these standards have been derivatized by treatment with the same reagent. The invention also provides kits that include one or more control dried blood samples that include known amounts of thyroxine, an isotopically enriched thyroxine standard, and instructions for using the kit to measure thyroxine levels in dried blood samples by mass spectrometry. The kits may also include other isotopically enriched standards including amino acid and/or carnitine standards. In certain embodiments the kits also include an extraction solution. In one embodiment the standards are dissolved in an extraction solution.

### BRIEF DESCRIPTION OF THE DRAWING

FIG. 1 shows a mass spectrum of one embodiment of the invention. The spectrum was obtained from a sample derived from a dried blood spot using a PE Sciex API 3000 tandem mass spectrometer. The mass spectrometer was equipped with a Perkin Elmer Series 200 HPLC pump and autoinjector. Thyroxine was detected as a t-butyl ester in multiple reaction monitoring (MRM) mode at a transition of 833.8→731.8 daltons. For the isotopically labelled thyroxine standard, the transition was 839.8→737.8 daltons. The concentration of thyroxine in the test sample can be calculated as the height of the thyroxine peak divided by the height of the thyroxine standard peak multiplied by the thyroxine standard concentration. The concentration of thyroxine in the dried blood spot can be obtained by further multiplying this value by a volume dilution factor and an experimentally determined extraction efficiency factor.

### DETAILED DESCRIPTION OF CERTAIN PREFERRED EMBODIMENTS

This application refers to a number of published documents including patents, patent applications and articles. The contents of these published documents are hereby incorporated by reference.

### I. Methods

In one aspect the present invention provides mass spectral methods for measuring thyroxine levels in samples that have been derived from dried blood samples. Mass spectrometry is performed on test samples that are obtained by first treating the dried blood samples with an extraction solution.

### Sample Preparation

The dried blood samples can be obtained from a patient by any means. In one embodiment, samples are obtained by pricking the patient's skin (e.g., a heel prick) and depositing whole blood on filter paper (or Guthrie cards) as one or more spots (e.g., see Millington et al., International Journal of Mass Spectrometry and Ion Processes 111:211, 1991). The spot or spots are then punched (e.g., with a diameter in the range of about 3/16 inches to 2/16 inches) and placed into a container. For example, different spots can be placed within different wells of a microtiter plate.

The dried blood samples are then treated with an extraction solution. Any solution that is able to extract an amount of thyroxine from dried blood samples may be used for this purpose. Preferred solutions are those that extract the greatest amount of thyroxine. Without limitation this includes a variety of organic solvents (with or without water) such as acetonitrile, ethanol, methanol, etc. In one embodiment the extraction solution includes methanol. The present invention also encompasses the use of additives that facilitate the release of thyroxine from dried blood samples, e.g., denaturing agents such as DMSO, urea, dithiothreitol, etc. In certain embodiments, the pH of the extraction solution may be optimized to enhance the amount of T₄ released into the supernatant. As described in U.S. Pat. No. 4,299,812, higher pHs increase the hydrophilic character of T₄ and thereby reduce associations with hydrophobic entities. The optimal pH in U.S. Pat. No. 4,299,812 was about 9.2 however they noted that for different methodologies the optimal pH would likely be somewhere in the general vicinity of the pK of the alpha-amino group (about 10.1). Thus in certain embodiments of the invention, the pH of the extraction solution is in the range of about 8-11, preferably about 9-10.

A volume of the extraction solution is added to each container that includes a dried blood sample. This can be done manually or preferably using automated sample handling equipment. Once the extraction solution had been added to each sample well, the samples are eluted, e.g., for 30 minutes on a shaker table using gentle shaking action. The supernatant is then removed from each container and the remnants of the blood samples are discarded. The solvent in the supernatant is finally removed, e.g., by evaporation using heated nitrogen flow.

In certain embodiments, the extracted thyroxine can then be treated with a reagent that derivatizes thyroxine. Although this derivatization step is not required it can be useful since it adds a known group to thyroxine that can be used as a marker for detecting thyroxine during mass spectral analysis. A variety of reagents for derivatizing thyroxine have been described in the art that can be used for this purpose. For example, De Brabandere et al. describe the preparation of the N,O-bis(perfluoroacyl) methyl ester of thyroxine using a reagent consisting of trimethylchlorosilane in methanol (De Brabandere et al., J. Mass Spec. 33:1032, 1998). Siekmann and Moller et al. (both supra) describe methods for preparing the N,O-bis(trifluoroacetyl) methyl ester of thyroxine. Ramsden et al. (supra) describe a method for preparing the N,O-bis(heptafluorobutyryl) methyl ester of thyroxine. Thienpont et al. describe yet other derivatives that are prepared using a variety of reagents (Biol. Mass Spectrom. 23(8):475-82, 1994). The Examples in this application describe a simple method for preparing the butyl ester derivative of thyroxine using an acidic butanol solution.

The test sample that is eventually analyzed by mass spectrometry comprises an isotopically enriched thyroxine standard. When the dried blood sample is treated with a reagent that derivatizes thyroxine then the isotopically enriched thyroxine standard may also be derivatized with the same reagent. As discussed in the Examples, in certain embodiments inclusion of a derivatized thyroxine standard can be achieved by adding the standard to the extraction solution that is used to treat the original dried blood sample. It will be appreciated however, that the thyroxine standard may be added at a different time. For example, the thyroxine standard could be added after extraction and before treatment with the derivatizing reagent. Alternatively, the thyroxine standard could be derivatized independently and then added once the extracted thyroxine has been treated. Further, any isotopically enriched thyroxine standard can be used for the purposes of this invention. Thyroxine includes a number of atoms for which isotopes exist, namely hydrogen, carbon, nitrogen, oxygen and iodine. Among these, hydrogen, nitrogen and carbon have the most readily available isotopes, in particular ²H, ¹⁵N and ¹³C. The atom and position that will be enriched in the thyroxine standard will mostly depend on commercial availability or ease of synthesis. Thus, Moller et al. (supra) describe the use of a ²H₂-thyroxine; Ramsden et al. (supra) describe the use of a ²H₅-thyroxine; while Siekmann (supra) describes the use of a ¹³C₂-thyroxine. As described in the Examples, Cambridge Isotope Laboratories, Inc. of Andover, Mass. sell a ¹³C₆-thyroxine where the six carbon atoms on the tyrosine ring are enriched (Catalog No. CLM-6725).

### Mass Spectral Analysis

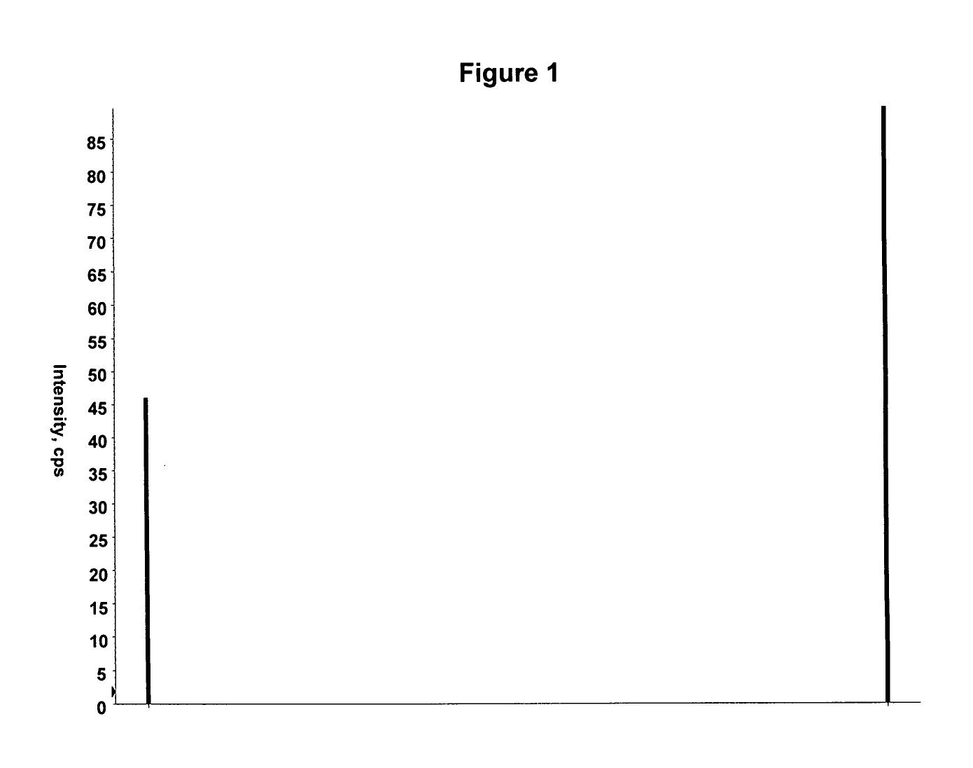

The test sample is then scanned using a mass spectrometer to produce one or more mass spectra. Any mass spectrometer that can detect a signal from the extracted thyroxine and the thyroxine standard can be used in the inventive methods. A tandem mass spectrometer is used in certain embodiments because it readily identifies different molecular entities that produce a common fragment when subjected to collision-induced dissociation (CID). This approach applies to underivatized or derivatized thyroxine. For example, when thyroxine is derivatized with a butyl ester group as described in the Examples, the resulting molecule produces a neutral loss fragment with an m/z value of 102. The isotopically enriched thyroxine and the natural thyroxine from the dried blood spot produce this same fragment (thyroxine fragmentation involves a 102 neutral mass loss from 833.8→731.8 daltons while ¹³C₆-thyroxine fragmentation involves a neutral mass loss from 839.8→737.8 daltons). By setting the second mass spectral detector (located after the fragmentation chamber) to detect ions with a value difference of 102 daltons and scanning the first mass spectral detector over an m/z range of about 800-880, thyroxine and the thyroxine standard are detected with high sensitivity. This approach is commonly referred to as multiple reaction monitoring (MRM) and it will be appreciated that it is equally applicable to non-derivatized thyroxine or alternative derivatizations of thyroxine. All that is required is a common fragment. FIG. 1 shows an exemplary mass spectrum that was obtained using this approach.

The level of thyroxine in the test sample is then determined by comparing a peak in the one or more mass spectra that corresponds to thyroxine with a peak in the one or more mass spectra that corresponds to the isotopically enriched thyroxine standard. In one embodiment, relative peak heights are used. In another embodiment, the areas under the peaks are integrated and compared.

When the level of thyroxine in the original dried blood sample is desired one needs to take into account the thyroxine extraction efficiency of the extraction solution. Indeed, as noted in the background and in the Examples, the extraction of thyroxine from dried blood (and even serum) is difficult and never complete. In one embodiment, the thyroxine extraction efficiency of the extraction solution is determined by repeating the inventive method using dried control blood samples to which a known amount of thyroxine has been added. This approach relies on the fact that the added thyroxine equilibrates with the endogenous thyroxine. The added thyroxine will therefore increase the amount of thyroxine detected by a fraction that is directly related to the amount of endogenous thyroxine present in the sample. By measuring changes in the amount of thyroxine detected as a function of the amount added one can readily calculate the total amount of endogenous thyroxine in the sample. Preferably, a range of samples are used that include different amounts of endogenous thyroxine and the extraction efficiency is averaged across all samples. As discussed in the Examples, the inventors have found that their extraction solution produces an average extraction efficiency of 24.1% (with range of about 20.5 to 27.7%).

It will be appreciated that the thyroxine level in the dried blood sample can be reported based on the average extraction efficiency. In certain embodiments, the thyroxine level can be reported as a range based on the known error range of the average extraction efficiency. It will also be appreciated that the extraction efficiency can be determined by measuring the total level of thyroxine using a known prior art method, e.g., an immunochemical method that is preceded by a more extensive extraction treatment.

Once the thyroxine level in a test sample or dried blood sample has been determined it can be compared with a range of normal thyroxine levels. If the level is outside this normal range then the dried blood sample or the patient from whom it was obtained may be referred for further analysis. For example, the test could be repeated with one or more additional blood spots to obtain an average level. Additionally or alternatively the thyroxine level could be measured using an alternative method known in the art, e.g., an immunochemical method or a mass spectral method using a serum sample. Additionally or alternatively the level of thyroid-stimulating hormone (TSH) could be measured using a method known in the art, e.g., an immunochemical method. In addition, it will be appreciated that the inventive methods can also be used to confirm a diagnosis for samples that have been referred based on the results from some other test (e.g., measurement of TSH).

Without limitation, the normal range of thyroxine levels in dried blood samples is currently thought to be about 60 to 155 nM (or 4.6 to 12 μg/dL). The normal range of thyroxine levels in the test samples of the invention will be lower than this range by a factor that is related to the thyroxine extraction efficiency (i.e., about 24.1% lower in the Examples). It will be appreciated that these ranges are exemplary and that the inventive methods are not limited to a given normal range of thyroxine levels. In particular, the normal range could be adjusted inward or outward as more results are gathered (e.g., with the inventive method) from larger samples of healthy patients. For example, in certain embodiments, one could use a more conservative upper cut-off of about 11 μg/dL or even about 10 μg/dL. Additionally or alternatively one could use a more conservative lower cut-off of about 5 μg/dL or even about 6 μg/dL. Generally, the choice of cut-off at either end of the normal range will be within the discretion of the person running the diagnostic test and may depend on the age, sex, health and/or medication of the patient from which the sample was obtained.

### Amino Acids and Carnitines

One advantage of the methods of the present invention is that they can be used to simultaneously measure thyroxine levels alongside amino acid and/or carnitine levels. As discussed in U.S. Pat. No. 6,455,321 and Chace et al., Clin. Chem. 49:1797-1817 (2003), these metabolites are commonly used as markers of metabolic diseases, especially in newborns.

When measuring thyroxine and an amino acid in parallel, the test sample will further include an isotopically enriched amino acid standard. In those embodiments in which the dried blood sample is treated with a reagent that derivatizes thyroxine, the amino acid standard may be derivatized by treatment with the same reagent as the dried blood sample. As with thyroxine, the level of the amino acid in the test sample can be determined by comparing a peak in the one or more mass spectra that corresponds to the amino acid with a peak in the one or more mass spectra that corresponds to the isotopically enriched amino acid standard. Extraction of amino acids from dried blood spots is far more efficient than for thyroxine and correction factors are therefore not generally required. As a result the level of a given amino acid in the test sample will often correspond to the level of the amino acid in the dried blood sample. However, in certain embodiments a correction factor can be used to account for the extraction efficiency of the extraction solution in determining the amino acid level in the original dried blood sample.

Exemplary isotopically enriched amino acid standards include ¹⁵N¹³C-glycine, ²H₄-alanine, ²H₈-valine, ²H₃-leucine, ²H₃-methionine, ²H₅-phenylalanine, ¹³C₆-phenylalanine, ¹³C₆-tyrosine, ²H₄-tyrosine, ²H₃-aspartate, ²H₃-glutamate, ²H₂-ornithine, ²H₂-citrulline and ²H₄¹³C-arginine. A useful subset of these is sold as a kit by Pediatrix Screening, Inc. of Bridgeville, Pa. and Cambridge Isotope Laboratories, Inc. of Andover, Mass.: ⁵N¹³C-glycine, ²H₄-alanine, ²H₈-valine, ²H₃-leucine, ²H₃-methionine, ²H₅-phenylalanine, ¹³C₆-tyrosine, ²H₃-aspartate, ²H₃-glutamate, ²H₂-ornithine, ²H₂-citrulline and ²H₄¹³C-arginine (Catalog No. NSK-A). Another subset of these is sold as a kit by Perkin Elmer of Wellesley, Mass.: ¹⁵N¹³C-glycine, ²H₄-alanine, ²H₈-valine, ²H₃-leucine, ²H₃-methionine, ²H₅-phenylalanine, ¹³C₆-tyrosine, ²H₂-ornithine, ²H₂-citrulline and ²H₄¹³C-arginine (Catalog No. 3026-0010).

When measuring thyroxine and a carnitine in parallel, the test sample will further include an isotopically enriched carnitine standard. In those embodiments in which the dried blood sample is treated with a reagent that derivatizes thyroxine, the carnitine standard may be derivatized by treatment with the same reagent as the dried blood sample. As with thyroxine, the level of the carnitine in the test sample can be determined by comparing a peak in the one or more mass spectra that corresponds to the carnitine with a peak in the one or more mass spectra that corresponds to the isotopically enriched carnitine standard. Extraction of carnitines from dried blood spots is far more efficient than for thyroxine and correction factors are therefore not generally required. As a result the level of a given carnitine in the test sample will often correspond to the level of the carnitine in the dried blood sample. However, in certain embodiments a correction factor can be used to account for the extraction efficiency of the extraction solution in determining the carnitine level in the original dried blood sample.

Exemplary isotopically enriched carnitine standards include ²H₉-carnitine, ²H₃-acetylcarnitine, ²H₃-propionylcarnitine, ²H₃-butyrylcarnitine, ²H₉-isovalerylcarnitine, ²H₆-glutarylcarnitine, ²H₃-hexanoylcarnitine, ²H₃-octanoylcarnitine, ²H₃-decanoylcarnitine, ²H₃-lauroylcarnitine, ²H₃-myristoylcarnitine, ²H₉-myristoylcarnitine, ²H₃-palmitoylcarnitine and ²H₃-octadecanoylcarnitine. Perkin Elmer of Wellesley, Mass. sells the following isotopically enriched carnitine standards as a kit: ²H₉-carnitine, ²H₃-acetylcarnitine, ²H₃-propionylcarnitine, ²H₃-butyrylcarnitine, ²H₉-isovalerylcarnitine, ²H₆-glutarylcarnitine, ²H₃-hexanoylcarnitine, ²H₃-octanoylcarnitine, ²H₃-decanoylcarnoylcarnitine, ²H₃-myristoylcarnitine, ²H₃-palmitoylcarnitine and ²H₃-octadecanoylcarnitine (Catalog No. 3026-0010). A different subset is sold as a kit by Pediatrix Screening, Inc. of Bridgeville, Pa. and Cambridge Isotope Laboratories, Inc. of Andover, Mass.: ²H₉-carnitine, ²H₃-acetylcarnitine, ²H₃-propionylcarnitine, ²H₃-butyrylcarnitine, ²H₉-isovalerylcarnitine, ²H₃-octanoylcarnitine, ²H₉-myristoylcarnitine and ²H₃-palmitoylcarnitine (Catalog No. NSK-B).

One of the advantages of measuring thyroxine levels in parallel with amino acid and/or carnitine levels is that it opens up the possibility of using ratios of these levels to improve the diagnostic power of the method. Indeed, in certain embodiments, ratios can be used to remove false positives or negatives (e.g., dried blood samples that have artificially low thyroxine and low amino acid levels because they included a weak or partial blood spot).

Thus in one embodiment, the inventive methods will involve determining a thyroxine:amino acid ratio and only referring patients or samples for further analysis if the thyroxine:amino acid ratio is outside a normal range. Alternatively one could limit referrals to situations in which both the thyroxine level and the thyroxine:amino acid ratio are outside normal ranges. It will be appreciated that a variety of ratios can be determined and used in this process. U.S. Pat. No. 6,455,321 and Chace et al., Clin. Chem. 49:1797-1817 (2003) provide normal ranges for various amino acids and carnitines in dried blood samples from newborns. These ranges can readily be combined with known ranges for thyroxine to produce the desired ratio ranges. Alternatively, normal ratio ranges can be determined directly from samples taken from a population of healthy newborns. In this context, the inventors have found that the level of phenylalanine in dried blood samples shows the least variability across healthy newborn populations. Accordingly, in certain embodiments a thyroxine:phenylalanine ratio is used instead of or in combination with thyroxine levels. This should serve to reduce the incidence of false positive or negative results.

In another embodiment, the inventive methods will involve determining a thyroxine:carnitine ratio and only referring patients or samples for further analysis if the thyroxine:carnitine ratio is outside a normal range. Alternatively one could limit referrals to situations in which both the thyroxine level and the thyroxine:carnitine ratio are outside normal ranges. It will be appreciated that a variety of ratios can be determined and used in this process.

When a reagent is used to derivatize thyroxine then, in certain embodiments, the reagent also derivatizes amino acids and/or carnitines under the same conditions. Without limitation, exemplary reagents that derivatize thyroxine, amino acids and/or carnitines under the same reaction conditions include the butyl esterifying reagents that are described in the Examples. Methods for detecting derivatized and underivatized amino acids or carnitines from dried blood samples are extensively described in Chace et al., Clin. Chem. 49:1797-1817 (2003).

In certain embodiments, the method may include one or more quality control steps. For example, if the thyroxine standard is derivatized in the same reaction as the endogenous thyroxine (e.g., when the thyroxine standard is included in the extraction solution) then the level of underivatized standard can be used to flag poorly prepared samples. The peak(s) for the underivatized standard will be shifted from those of the derivatized standard by a known amount which corresponds to the derivatizing group (e.g., a butyl group). When the peak(s) of the underivatized standard are above a certain threshold, the level of derivatization was poor which could skew the results. New test samples can therefore be requested for samples that are flagged on this basis.

### II. Compositions

The present invention also provides compositions that are used in inventive methods. Thus, a composition comprising an isotopically enriched thyroxine standard in combination with an isotopically enriched amino acid standard is provided. Similarly, a composition comprising an isotopically enriched thyroxine standard in combination with an isotopically enriched carnitine standard is provided. Compositions that comprise an isotopically enriched thyroxine standard in combination with an isotopically enriched amino acid standard and an isotopically enriched carnitine standard are also encompassed.

In certain embodiments, the isotopically enriched thyroxine standard in these compositions can be selected from the group consisting of ²H₂-thyroxine, ²H₅-thyroxine, ¹³C₂-thyroxine and ¹³C₆-thyroxine. In one embodiment the isotopically enriched thyroxine standard is ¹³C₆-thyroxine.

In certain embodiments, the isotopically enriched amino acid standard in these compositions can be selected from the group consisting of ¹⁵N¹³C-glycine, ²H₄-alanine, ²H₈-valine, ²H₃-leucine, ²H₃-methionine, ²H₅-phenylalanine, ¹³C₆-phenylalanine, C₁₃C₆-tyrosine, ²H₄-tyrosine, ²H₃-aspartate, ²H₃-glutamate, ²H₂-ornithine, ²H₂-citrulline and ²H₄¹³C-arginine.

In certain embodiments, the isotopically enriched carnitine standard can be selected from the group consisting of ²H₉-carnitine, ²H₃-acetylcarnitine, ²H₃-propionylcarnitine, ²H₃-butyrylcarnitine, ²H₉-isovalerylcarnitine, ²H₆-glutarylcarnitine, ²H₃-hexanoylcarnitine, ²H₃-octanoylcarnitine, ²H₃-decanoylcarnitine, ²H₃-lauroylcarnitine, ²H₃-myristoylcarnitine, ²H₉-myristoylcarnitine, ²H₃-palmitoylcarnitine and ²H₃-octadecanoylcarnitine.

In any of these embodiments, the standards can be derivatized by treatment with the same reagent. In one embodiment the standards in the composition have all been butyl esterified.

### III. Kits

The present invention also provides kits that can be used to practice the inventive methods. In one aspect, the invention provides a kit that includes a control dried blood sample with a known amount of thyroxine; an isotopically enriched thyroxine standard; and instructions for using the kit to measure thyroxine levels in dried blood samples by mass spectrometry. The control blood sample could be on filter paper. In one embodiment the kit includes two or more control dried blood samples with different amounts of thyroxine. The instructions would be based on the inventive methods that have been described above.

In certain embodiments, the isotopically enriched thyroxine standard in these kits is selected from the group consisting of ²H₂-thyroxine, ²H₅-thyroxine, ¹³C₂-thyroxine and ¹³C₆-thyroxine. In one embodiment, the isotopically enriched thyroxine standard is ¹³C₆-thyroxine.

In one embodiment, the kits also include one or both of an isotopically enriched amino acid standard and an isotopically enriched carnitine standard. In certain embodiments, the isotopically enriched amino acid standard can selected from the group consisting of ¹⁵N¹³C-glycine, ²H₄-alanine, ²H₈-valine, ²H₃-leucine, ²H₃-methionine, ²H₅-phenylalanine, ¹³C₆-phenylalanine, ¹³C₆-tyrosine, ²H₄-tyrosine, ²H₃-aspartate, ²H₃-glutamate, ²H₂-ornithine, ²H₂-citrulline and ²H₄¹³C-arginine. In certain embodiments, the isotopically enriched carnitine standard can be selected from the group consisting of ²H₉-carnitine, ²H₃-acetylcarnitine, ²H₃-propionylcarnitine, ²H₃-butyrylcarnitine, ²H₉-isovalerylcarnitine, ²H₆-glutarylcarnitine, ²H₃-hexanoylcarnitine, ²H₃-octanoylcarnitine, ²H₃-decanoylcarnitine, ²H₃-lauroylcarnitine, ²H₃-myristoylcarnitine, ²H₉-myristoylcarnitine, ²H₃-palmitoylcarnitine and ²H₃-octadecanoylcarnitine.

In one set of embodiments, the kit also includes an extraction solution that is suitable for extracting an amount of thyroxine from the control dried blood sample. Without limitation the extraction solution can include a variety of organic solvents (with or without water) such as acetonitrile, ethanol, methanol, etc. In one embodiment the extraction solution includes methanol. In one embodiment, the isotopically enriched thyroxine standard and optionally the amino acid and/or carnitine standard is dissolved in an extraction solution. The kit can also include a reagent suitable for derivatizing thyroxine. Without limitation, this reagent could be an acidic butanol solution.

### EXAMPLES

### Extracting Thyroxine from Dried Blood Samples

Dried filter paper blood samples were punched using a Perkin Elmer-Wallac 1296-071 puncher fitted with a 3/16 inch punch head into an Evergreen 290-8115-01F untreated 96-well flat bottom plate. 300 μL of extraction solution containing an isotopically enriched thyroxine standard (0.00159 μM) was added to each sample well using the Gilson 215 liquid handling system.

The extraction solution was prepared as follows:

(a) a 2 mg/mL stock solution of an isotopically enriched thyroxine standard (thyroxine-tyrosine ring-¹³C₆, special order from Cambridge Isotope Laboratories, Inc. of Andover, Mass.) was prepared by weighing 3.2 mg of the thyroxine standard into a 4 mL glass vial with rubber lined cap (Wheaton 224882) and adding 1.6 mL of 0.1 M NaOH. The concentration of thyroxine standard in the stock solution was 2555 μM.

(b) 100 μL of the 2 mg/mL stock solution was then added to 900 μL of 50:50 water/methanol to produce solution A. The concentration of thyroxine standard in solution A was 255.5 μM and the volume ratio of water/methanol was 55:45.

(c) 100 μL of solution A was then added to 900 μL of methanol to produce diluted solution B. The concentration of thyroxine standard in solution B was 25.55 μM and the volume ratio of water/methanol was about 5:95.

(d) 25 μL of solution B was then added to 975 μL of methanol to produce diluted solution C. The concentration of thyroxine standard in solution C was 0.63875 μM and the volume ratio of water/methanol was about 0.1:99.9.

(e) 74.7 μL of solution C was then added to 30 mL of methanol to produce the extraction solution containing the isotopically enriched thyroxine standard. The concentration of the standard in the extraction solution was 0.00159 μM and the water content was now minimal.

A 3/16″ filter paper blood spot provides the equivalent of 7.6 μL of a patient's blood. The extraction solution extracts an amount of thyroxine from this blood spot which becomes diluted within the 300 μL of extraction solution. The measured level of thyroxine in the extraction solution is therefore reduced as compared to the original blood spot by a factor of about 39.47 because of the volume dilution (300 μL/7.6 μL=39.47). In addition, the extraction efficiency of the thyroxine extraction solvent is not absolute. Experiments with control dried blood samples with known amounts of thyroxine revealed that the extraction efficiency of this particular extraction solvent was about 24.1%. Accordingly, the measured level of thyroxine in the extraction solution needs to be further factored up by about 4.15 to yield the level in the original dried blood sample.

For experiments in which amino acid and carnitine levels were also measured, 200 μL of an amino acid and acylcarnitine standard mix were added in step (e) along with the 30 mL of methanol for a total final volume of 30.2747 mL. The concentration of thyroxine standard was only slightly different in this case at 0.00158 μM.

Once the extraction solution had been added to each sample well, the samples were eluted for 30 minutes on a shaker table using gentle shaking action. The Gilson was then used to transfer the liquid from the flat bottom plate wells to an Evergreen 290-8117-01R untreated 96-well round bottom plate. The flat bottom plate containing the blood spots was then discarded. Solvent was then removed using heated nitrogen flow of 50° C. on the wells and 70° C. from below on an Evaporex EVX-96.

### Derivatizing Samples

Butyl esterification of thyroxine (and any amino acids and carnitines present) was accomplished by reaction with 50 μL of butanol in 3.0 M HCl (Regis Technology 201009) for 15 minutes in a 65° C. oven. Due to the acidity, the reagent was added by hand using an Eppendorf repeating pipette. The liquid was removed by heated nitrogen flow as before. The samples were then reconstituted in 100 μL of 50:50 acetonitrile/water with 0.02% formic acid using the Gilson. A Sun 300 002 mat was applied to seal the wells of the plate.

### Obtaining Mass Spectra

10 μL from each sample was injected into the electrospray ion source for analysis by a PE Sciex API 3000 tandem mass spectrometer. The mass spectrometer was equipped with a Perkin Elmer Series 200 HPLC pump and autoinjector. A flow rate of 18 μL/min was used through a Polymicro 2000018 silica line with 75 μm internal diameter. The mobile phase was 50:50 acetonitrile/water with 0.02% formic acid. The collision gas used was nitrogen. A collision energy of 42 eV was used at a dwell time of 0.5 seconds. Thyroxine was detected as a t-butyl ester in multiple reaction monitoring (MRM) mode at a transition of 833.8→731.8 daltons. For the isotopically labeled thyroxine standard, the transition was 839.8→737.8 daltons. FIG. 1 shows an exemplary mass spectrum from one of these samples.

### Analyzing Results

The concentration of thyroxine in each test sample was calculated as the height of the thyroxine peak divided by the height of the thyroxine standard peak multiplied by the thyroxine standard concentration (e.g., 1.59 nM). The concentration of thyroxine in the original dried blood samples was calculated by further multiplying this value by the volume dilution factor (i.e., 39.47) and the experimentally determined extraction efficiency factor (i.e., 4.15). ChemoView software was used to do this on the entire 96 well plate. Low thyroxine values in test samples or dried blood samples indicated the need for further testing (e.g., blood TSH) to check for hypothyroidism. High thyroxine values in test samples or dried blood samples indicated the need for further testing to check for hyperthyroidism.

### Other Embodiments

The foregoing has been a description of certain non-limiting preferred embodiments of the invention. Those of ordinary skill in the art will appreciate that various changes and modifications to this description may be made without departing from the spirit or scope of the present invention, as defined in the following claims.

What is claimed is:

1. A method comprising steps of:
providing a test sample that was obtained by treating a dried blood sample with an extraction solution, wherein the test sample comprises an isotopically enriched thyroxine standard;
scanning the test sample using a mass spectrometer to produce one or more mass spectra; and
determining the level of thyroxine in the test sample by comparing a peak in the one or more mass spectra that corresponds to thyroxine with a peak in the one or more mass spectra that corresponds to the isotopically enriched thyroxine standard.

2. The method of claim 1 further comprising:
determining the level of thyroxine in the dried blood sample based on the thyroxine extraction efficiency of the extraction solution.

3. The method of claim 1, wherein the dried blood sample is a dried blood spot on filter paper.

4. The method of claim 1, wherein the extraction solution comprises an organic solvent selected from the group consisting of acetonitrile, ethanol and methanol.

5. The method of claim 4, wherein the organic solvent is methanol.

6. The method of claim 1, wherein the isotopically enriched thyroxine standard is selected from the group consisting of ²H₂-thyroxine, ²H₅-thyroxine, ¹³C₂-thyroxine and ¹³C₆-thyroxine.

7. The method of claim 6, wherein the isotopically enriched thyroxine standard is ¹³C₆-thyroxine.

8. The method of claim 1, wherein the test sample was obtained by further treating the dried blood sample with a reagent that derivatives thyroxine and wherein the test sample comprises an isotopically enriched thyroxine standard that has been derivatized by treatment with the reagent.

9. The method of claim 8, wherein the reagent butyl esterifies thyroxine.

10. The method of claim 1, wherein the mass spectrometer is a tandem mass spectrometer and the one or more mass spectra are obtained using a multiple reaction monitoring mode.

11. The method of claim 2, wherein the thyroxine extraction efficiency of the extraction solution is based on results of an experiment in which the steps of claim 1 were performed with one or more control dried blood samples that each included a known amount of thyroxine.

12. The method of claim 1 or 2, wherein the test sample further comprises an isotopically enriched amino acid standard, the method further comprising:
determining the level of an amino acid in the test sample or dried blood sample by comparing a peak in the one or more mass spectra that corresponds to the amino acid with a peak in the one or more mass spectra that corresponds to the isotopically enriched amino acid standard.

13. The method of claim 12, wherein the isotopically enriched amino acid standard is selected from the group consisting of ¹⁵N¹³C-glycine, ²H₄-alanine, ²H₈-valine, ²H₃-leucine, ²H₃-methionine, ²H₅-phenylalanine, ¹³C₆-phenylalanine, ¹³C₆-tyrosine, ²H₄-tyrosine, ²H₃-aspartate, ²H₃-glutamate, ²H₂-ornithine, ²H₂-citrulline and ²H₄¹³C-arginine.

14. The method of claim 12, wherein the isotopically enriched amino acid standard has been derivatized by treatment with the same reagent as the isotopically enriched thyroxine standard.

15. The method of claim 1 or 2, wherein the test sample further comprises an isotopically enriched carnitine standard, the method further comprising:
determining the level of a carnitine in the test sample or dried blood sample by comparing a peak in the one or more mass spectra that corresponds to the carnitine with a peak in the one or more mass spectra that corresponds to the isotopically enriched carnitine standard.

16. The method of claim 15, wherein the isotopically enriched carnitine standard is selected from the group consisting of ²H₉-carnitine, ²H₃-acetylcarnitine, ²H₃-propionylcarnitine, ²H₃-butyrylcarnitine, ²H₉-isovalerylcarnitine, ²H₆-glutarylcarnitine, ²H₃-hexanoylcarnitine, ²H₃-octanoylcarnitine, ²H₃-decanoylcarnitine, ²H₃-lauroylcarnitine, ²H₃-myristoylcarnitine, ²H₉-myristoylcarnitine, ²H₃-palmitoylcarnitine and ²H₃-octadecanoylcarnitine.

17. The method of claim 15, wherein the isotopically enriched carnitine standard has been derivatized by treatment with the same reagent as the isotopically enriched thyroxine standard.

18. The method of claim 1, wherein the extraction solution included the isotopically enriched thyroxine standard when it was used to treat the dried blood sample.

19. The method of claim 12, wherein the extraction solution included the isotopically enriched amino acid standard when it was used to treat the dried blood sample.

20. The method of claim 15, wherein the extraction solution included the isotopically enriched carnitine standard when it was used to treat the dried blood sample.

21. The method of claim 1 or 2 further comprising:
referring the dried blood sample or the patient from whom it was obtained for further analysis if the level of thyroxine in the test sample or dried blood sample is outside a range of normal thyroxine levels.

22. The method of claim 12 further comprising:
determining a thyroxine:amino acid ratio for the test sample or dried blood sample by dividing the determined thyroxine level by the determined amino acid level; and
referring the dried blood sample or the patient from whom it was obtained for further analysis if the thyroxine:amino acid ratio in the test sample or dried blood sample is outside a range of normal thyroxine:amino acid ratios.

23. The method of claim 12 further comprising:
determining a thyroxine:amino acid ratio for the test sample or dried blood sample by dividing the determined thyroxine level by the determined amino acid level; and
referring the dried blood sample or the patient from whom it was obtained for further analysis if the level of thyroxine and the thyroxine:amino acid ratio in the test sample or dried blood sample are outside a range of normal thyroxine levels and a range of normal thyroxine:amino acid ratios, respectively.

24. The method of claim 22, wherein the thyroxine:amino acid ratio is between thyroxine and phenylalanine.

25. The method of claim 23, wherein the thyroxine:amino acid ratio is between thyroxine and phenylalanine.

26. The method of claim 15 further comprising:
determining a thyroxine:carnitine ratio for the test sample or dried blood sample by dividing the determined thyroxine level by the determined carnitine level; and
referring the dried blood sample or the patient from whom it was obtained for further analysis if the thyroxine:carnitine ratio in the test sample or dried blood sample is outside a range of normal thyroxine:carnitine ratios.

27. The method of claim 15 further comprising:
determining a thyroxine:carnitine ratio for the test sample or dried blood sample by dividing the determined thyroxine level by the determined carnitine level; and
referring the dried blood sample or the patient from whom it was obtained for further analysis if the level of thyroxine and the thyroxine:carnitine ratio in the test sample or dried blood sample are outside a range of normal thyroxine levels and a range of normal thyroxine: carnitine ratios, respectively.

28. A composition comprising an isotopically enriched thyroxine standard in combination with an isotopically enriched amino acid standard.

29. A composition comprising an isotopically enriched thyroxine standard in combination with an isotopically enriched carnitine standard.

30. A composition comprising an isotopically enriched thyroxine standard in combination with an isotopically enriched amino acid standard and an isotopically enriched carnitine standard.

31. The composition of any one of claims 28-30, wherein the isotopically enriched thyroxine standard is selected from the group consisting of ²H₂-thyroxine, ²H₅-thyroxine, ¹³C₂-thyroxine and ¹³C₆-thyroxine.

32. The composition of claim 31, wherein the isotopically enriched thyroxine standard is ¹³C₆-thyroxine.

33. The composition of claim 28 or 30, wherein the isotopically enriched amino acid standard is selected from the group consisting of ¹⁵N¹³C-glycine, ²H₄-alanine, ²H₈-valine, ²H₃-leucine, ²H₃-methionine, ²H₅-phenylalanine, ¹³C₆-phenylalanine, ¹³C₆-tyrosine, ²H₄-tyrosine, ²H₃-aspartate, ²H₃-glutamate, ²H₂-omithine, ²H₂-citrulline and ²H₄¹³C-arginine.

34. The composition of claim 29 or 30, wherein the isotopically enriched carnitine standard is selected from the group consisting of ²H₉-carnitine, ²H₃-acetylcarnitine, ²H₃-propionylcarnitine, ²H₃-butyrylcarnitine, ²H₉-isovalerylcarnitine, ²H₆-glutarylcarnitine, ²H₃-hexanoylcarnitine, ²H₃-octanoylcarnitine, ²H₃-decanoylcarnitine, ²H₃-lauroylcarnitine, ²H₃-myristoylcarnitine, ²H₉-myristoylcarnitine, ²H₃-palmitoylcarnitine and ²H₃-octadecanoylcarnitine.

35. The composition of any one of claims 28-30, wherein the standards have been derivatized by treatment with the same reagent.

36. The composition of claim 35, wherein the standards have been butyl esterified.

37. A kit comprising:
a control dried blood sample that includes a known amount of thyroxine;
an isotopically enriched thyroxine standard; and
instructions for using the kit to measure thyroxine levels in dried blood samples by mass spectrometry.

38. The kit of claim 37, wherein the isotopically enriched thyroxine standard is selected from the group consisting of ²H₂-thyroxine, ²H₅-thyroxine, ¹³C₂-thyroxine and ¹³C₆-thyroxine.

39. The kit of claim 38, wherein the isotopically enriched thyroxine standard is ¹³C₆-thyroxine.

40. The kit of claim 37 further comprising one or both of an isotopically enriched amino acid standard and an isotopically enriched carnitine standard.

41. The kit of claim 40, wherein the isotopically enriched amino acid standard is selected from the group consisting of ¹⁵N¹³C-glycine, ²H₄-alanine, ²H₈-valine, ²H₃-leucine, ²H₃-methionine, ²H₅-phenylalanine, ¹³C₆-phenylalanine, ¹³C₆-tyrosine, ²H₄-tyrosine, ²H₃-aspartate, ²H₃-glutamate, ²H₂-ornithine, ²H₂-citrulline and ²H₄¹³C-arginine.

42. The kit of claim 40, wherein the isotopically enriched carnitine standard is selected from the group consisting of ²H₉-carnitine, ²H₃-acetylcarnitine, ²H₃-propionylcarnitine, ²H₃-butyrylcarnitine, ²H₉-isovalerylcarnitine, ²H₆-glutarylcarnitine, ²H₃-hexanoylcarnitine, ²H₃-octanoylcarnitine, ²H₃-decanoylcarnitine, ²H₃-lauroylcarnitine, ²H₃-myristoylcarnitine, ²H₉-myristoylcarnitine, ²H₃-palmitoylcarnitine and ²H₃-octadecanoylcarnitine.

43. The kit of claim 37 further comprising an extraction solution suitable for extracting an amount of thyroxine from the control dried blood sample.

44. The kit of claim 43, wherein the extraction solution comprises an organic solvent selected from the group consisting of acetonitrile, ethanol and methanol.

45. The kit of claim 44, wherein the organic solvent is methanol.

46. The kit of claim 43, wherein the isotopically enriched thyroxine standard is dissolved in the extraction solution.

47. The kit of claim 37 further comprising a reagent suitable for derivatizing thyroxine.

48. The kit of claim 47, wherein the reagent is an acidic butanol solution.
